(19) United States
(12) Patent Application Publication
(10) Pub. No.: US 2012/0098555 A1
(43) Pub. Date: Apr. 26, 2012

(54) LIQUID DETECTION CABLE

(76) Inventor: Donald M. Raymond, Fort Collins, CO (US)

(21) Appl. No.: 13/279,133

(22) Filed: Oct. 21, 2011

Related U.S. Application Data
(60) Provisional application No. 61/405,539, filed on Oct. 21, 2010.

(51) Int. Cl. G01N 27/04; H01R 43/00

(52) U.S. Cl. 324/694; 29/825

(57) ABSTRACT

Disclosed is a liquid detection cable that is capable of quickly detecting the presence of liquid and resetting, so that the liquid detection cable can be reused after removal from the presence of a liquid. The liquid detection cable uses a reactive layer that has not been doped with a conductive material, rather, a conductive layer is used adjacent the reactive layer, which allows the reactive layer to react quickly and reset after removal from the presence of the liquid. A braided binder is also provided between sensor wires and the conductive layer to provide a layer of insulation, so that the liquid detection cable does not provide false alarms when an external force is applied to the cable.

### CROSS-REFERENCE TO RELATED APPLICATION

The present application is based upon and claims the benefit of U.S. Provisional Patent Application No. 61/405,539, entitled “CHEMICAL LEAK DETECTION CABLE”, filed Oct. 21, 2010, by Donald M. Raymond. The entire content of the above-mentioned application is hereby specifically incorporated herein by reference for all it discloses and teaches.

### BACKGROUND OF THE INVENTION

Liquid detection cables are employed to detect the presence of various liquid chemicals, such as liquid petrochemicals, including gasoline, oil, solvents, etc. Liquid detection cables are typically connected to detector electronics, which are, in turn, connected to an alarm that signals the presence of a liquid to be detected. Liquid petrochemical detection cables can be used in tank farms, petrochemical plants, refineries, airports and other locations where a petrochemical leak may occur. For example, petrochemical detection cables may be used in double wall containers for fuel transfer, such as jet fuel distribution. Petrochemical detection cables may also be placed around diesel generators to detect leaks from diesel storage tanks or leaks from the generator. Petrochemical detection cables may also be buried around underground tanks that store petrochemical fuels to detect if the underground tank is leaking and causing an environmental hazard.

### SUMMARY OF THE INVENTION

An embodiment of the present invention may therefore comprise a method of forming a liquid detection cable comprising: providing at least two sensor wires; placing insulating spacers between the sensor wires; surrounding the spacers with a binder layer that provides openings; surrounding the binder layer with a conductive layer that protrudes through the interstitial openings upon application of a force on the conductive layer; surrounding the conductive layer with a reactive layer that expands when contacted by a liquid; surrounding the reactive layer with a constricting layer that is capable of substantially constricting outward expansion of the reactive layer which causes the reactive layer to expand inwardly and force the conductive layer to contact the at least two sensor wires to provide a conductive path between the at least two sensor wires indicating the presence of a liquid chemical.

An embodiment of the present invention may further comprise a method of forming a liquid detection cable comprising: providing a first sensor wire and a second sensor wire; surrounding the first sensor wire with a binder layer that provides openings; surrounding the binder layer with a conductive layer that protrudes through the openings upon application of a force to the conductive layer; surrounding the conductive layer with a reactive layer that expands when contacted by a liquid; disposing the second sensor wire between the conductive layer and the reactive layer so that the second sensor wire is in electrical contact with the conductive layer; surrounding the reactive layer with a constricting layer that substantially constricts outward expansion of the reactive layer, causing the reactive layer to expand inwardly and force the conductive layer to be in electrical contact with the second sensor wire and force the conductive layer to protrude through the openings in the binder layer and contact the first sensor wire so that an electrical connection is made by the conductive layer between the first sensor wire and the second sensor wire.

An embodiment of the present invention may further comprise a liquid detection cable comprising: at least two sensor wires; spacers disposed between the sensor wires; a nonconductive binder layer that is disposed around the spacers and the at least two sensor wires, the non-conductive binder layer having openings; a conductive layer disposed around the nonconductive binder layer that protrudes through the openings upon application of a force on the conductive layer that is greater than a predetermined force; a reactive layer that is disposed around the conductive layer that expands when contacted by a liquid; a constricting layer surrounding the reactive layer that substantially constricts outward expansion of the reactive layer which causes the reactive layer to expand inwardly and generate a force on the conductive layer that is greater than the predetermined force so that the conductive layer contacts the at least two sensor wires to provide a conductive path between the at least two sensor wires indicating that the liquid is in the presence of the liquid detection cable.

An embodiment of the present invention may further comprise a liquid detection cable comprising: a first sensor wire; a second sensor wire; a non-conductive binder layer that is disposed around the first sensor wire, the non-conductive binder layer having openings; a conductive layer disposed around the non-conductive binder layer that protrudes through the openings upon application of a force on the conductive layer that is greater than a predetermined force; a reactive layer that is disposed around the conductive layer that expands when contacted by a liquid; a second sensor wire disposed between the conductive layer and the reactive layer so that the second sensor wire is in electrical contact with the conductive layer; a constricting layer surrounding the reactive layer that substantially constricts outward expansion of the reactive layer, causing the reactive layer to expand inwardly and force the conductive layer to be in electrical contact with the sensor wire and force the conductive layer to protrude through the openings in the binder layer and contact the first sensor wire so that an electrical connection is made by the conductive layer between the first sensor wire and the second sensor wire.

An embodiment of the present invention may further comprise a method of making a liquid detection cable comprising: providing at least two sensor wires; placing the sensor wires in grooves in a carrier so that gaps are created between an outside surface of the carrier and the sensor wires; surrounding the carrier and the sensor wires with a conductive layer that protrudes into the gaps upon application of a force on the conductive layer; surrounding the conductive layer with a reactive layer that expands when contacted by a liquid; surrounding the reactive layer with a constricting layer that is capable of substantially constricting outward expansion of the reactive layer which causes the reactive layer to expand inwardly and force the conductive layer into the gaps to contact the at least two sensor wires to provide a conductive path between the at least two sensor wires indicating the presence of a liquid.

An embodiment of the present invention may further comprise a liquid detection cable for detecting the presence of a liquid comprising: at least two sensor wires; a carrier having grooves formed in an outer surface of the carrier and the sensor wires disposed in the grooves so that gaps are present between the sensor wires and an outer surface of the carrier; a conductive layer disposed around the carrier and the sensor wires that protrudes into the gaps upon application of a force on the conductive layer; a reactive layer that is disposed around the conductive layer that expands when contacted by the liquid; a constricting layer surrounding the reactive layer that substantially constricts outward expansion of the reactive layer causing the reactive layer to expand inwardly and generate a force on the conductive layer so that the conductive layer protrudes into the gaps and contacts the at least two sensor wires to provide a conductive path between the at least two sensor wires indicating the presence of the liquid.

An embodiment of the present invention may further comprise a method of making a liquid detection cable comprising: placing a first sensor wire in a groove in a carrier so that a gap is created between an outside surface of the carrier and the first sensor wire; surrounding the carrier and the first sensor wire with a conductive layer that protrudes into the gap upon application of a force on the conductive layer; surrounding the conductive layer with a reactive layer that expands when contacted by a liquid; placing a second sensor wire between the conductive layer and the reactive layer so that the second sensor wire is in electrical contact with the conductive layer; surrounding the reactive layer with a constricting layer that substantially constricts outward expansion of the reactive layer which causes the reactive layer to expand inwardly and force the conductive layer into the gap so that the conductive layer contacts the first sensor wire and makes an electrical connection between the first sensor wire and the second sensor wire.

An embodiment of the present invention may further comprise a liquid detection cable for detecting the presence of a liquid comprising: a carrier having a groove formed in an outer surface; a first sensor wire disposed in the groove so that a gap is present between the first sensor wire and an outer surface of the carrier; a conductive layer disposed around the carrier and the first sensor wire that protrudes into the gap upon application of a force on the conductive layer; a reactive layer that is disposed around the conductive layer that expands when contacted by the liquid; a second sensor wire disposed between the conductive layer and the reactive layer so that the second sensor wire is in electrical contact with the conductive layer; a constricting layer surrounding the reactive layer that substantially constricts outward expansion of the reactive layer causing the reactive layer to expand inwardly and generate a force on the conductive layer so that the conductive layer protrudes into the gap and contacts the first sensor wire to provide a conduction path between the first sensor wire and the second sensor wire through the conductive layer indicating the presence of the liquid.

An embodiment of the present invention may further comprise a liquid detection cable comprising: sensor wire means for carrying a sensor signal; carrier means having a groove formed in an outer surface for carrying the sensor wire means so that a gap is created between the sensor wire means and the outer surface of the carrier means; conductive layer means disposed around the carrier means for creating an electrical path between the conductive layer and the sensor wire means when the conductive layer means protrudes into the groove upon application of a force on the conductive layer means; reactive layer means for absorbing and swelling in the presence of the liquid; constricting layer means disposed around the reactive layer means for constricting outward expansion of the reactive layer means and causing the reactive layer means to expand inwardly and generate the force on the conductive layer means so that the conductive layer means fills the gap and creates an electrical path between the sensor wire means.

### BRIEF DESCRIPTION OF THE DRAWINGS

FIG. 1A is a schematic perspective, cutaway view of one embodiment of a liquid detection cable.

FIG. 1B is a schematic end view of the embodiment of the liquid detection cable illustrated in FIG. 1A.

FIG. 2A is a schematic, perspective, cutaway view of another embodiment of a liquid detection cable.

FIG. 2B is an end view of the embodiment of FIG. 2A.

FIG. 3 is a schematic illustration of one application of a liquid detection cable.

FIG. 4A is a schematic isometric view of another embodiment of a liquid detection cable.

FIG. 4B is a cross-sectional view of the embodiment of FIG. 4A.

FIG. 5A is schematic, perspective, cutaway view of another embodiment of a liquid detection cable.

FIG. 5B is a cross-section view of the embodiment of FIG. 5A.

### DETAILED DESCRIPTION OF THE INVENTION

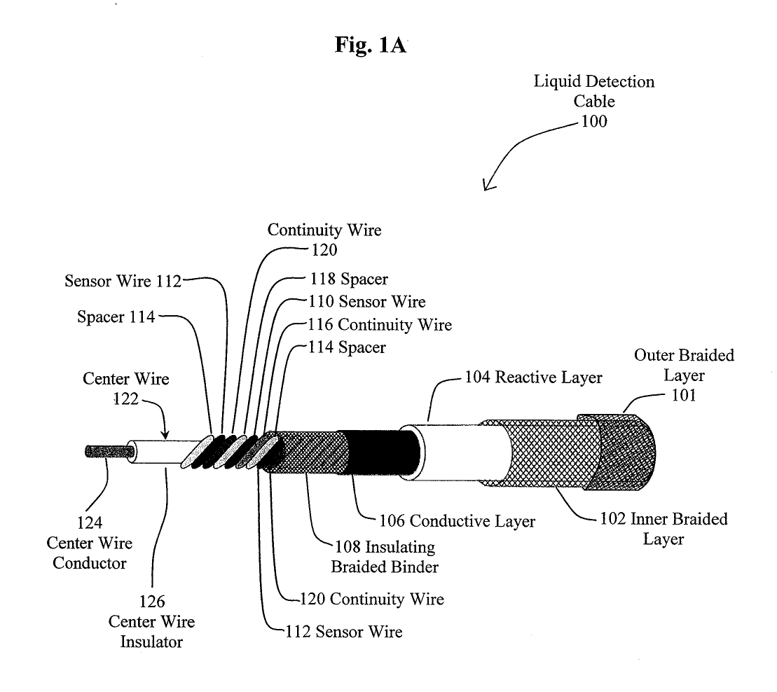

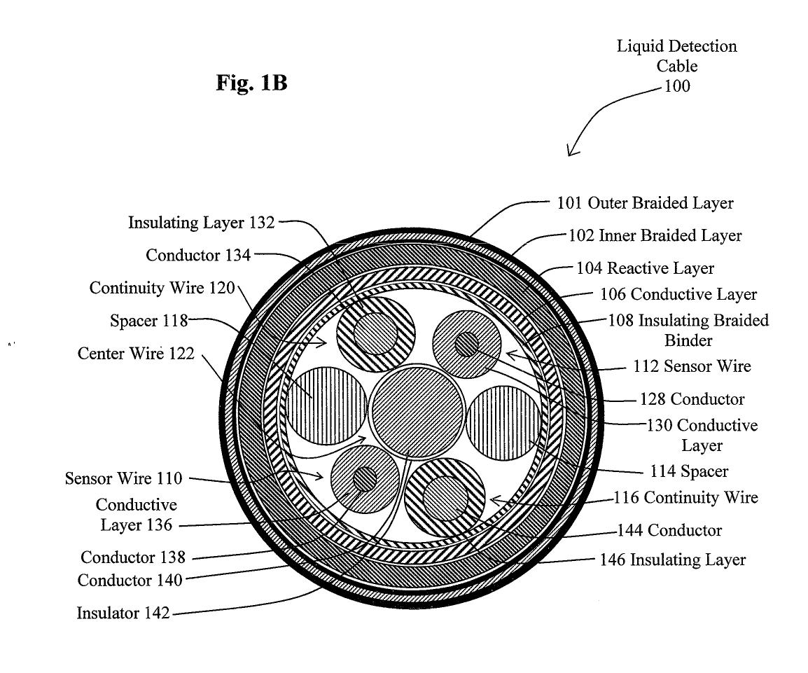

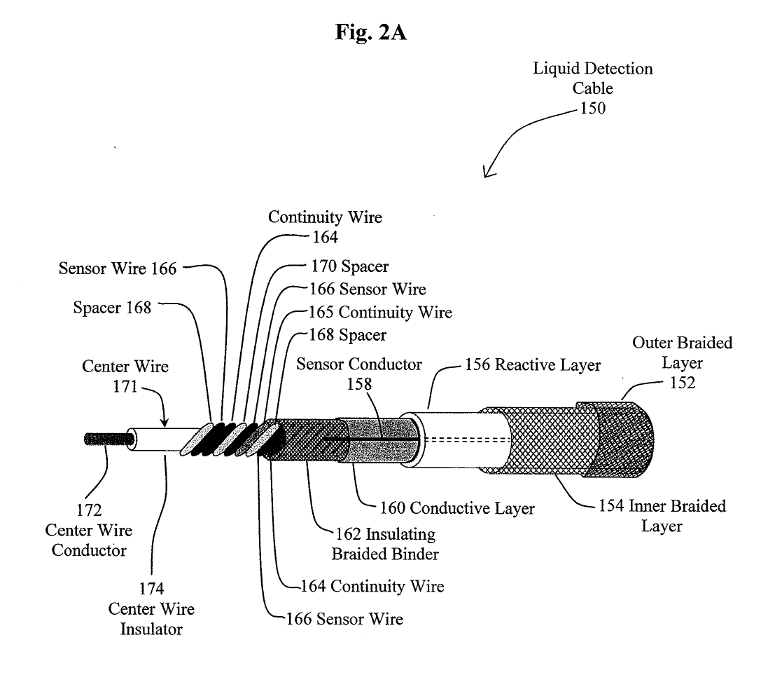

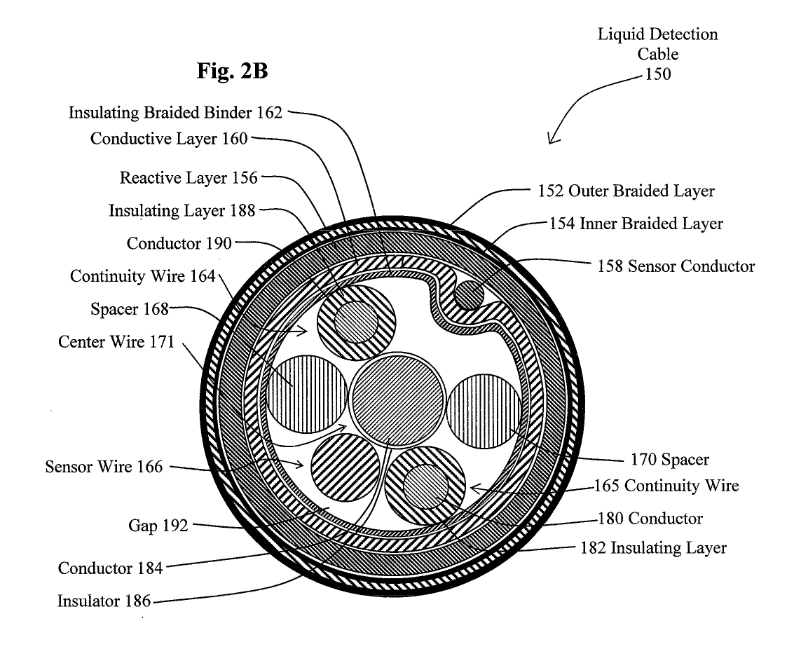

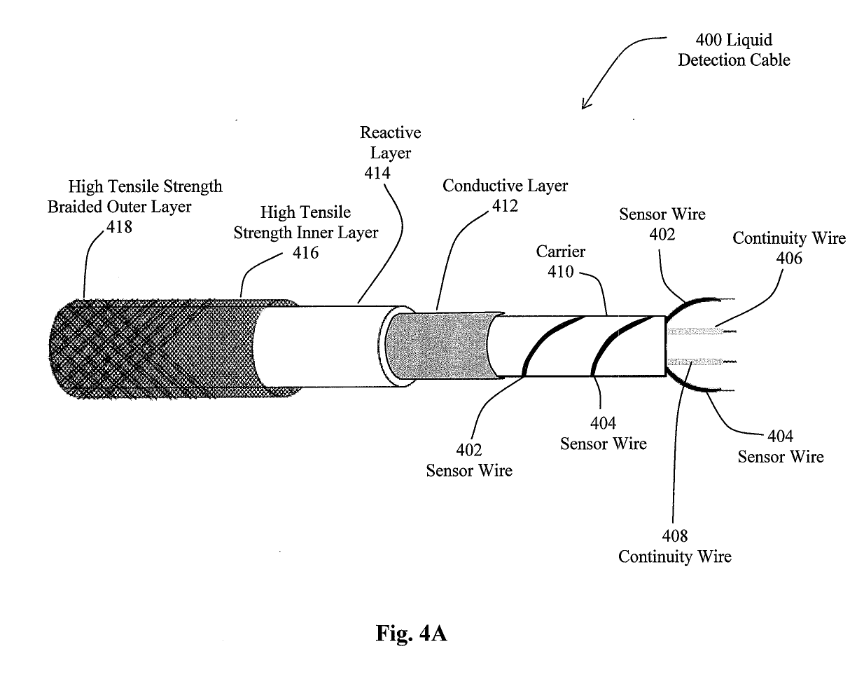

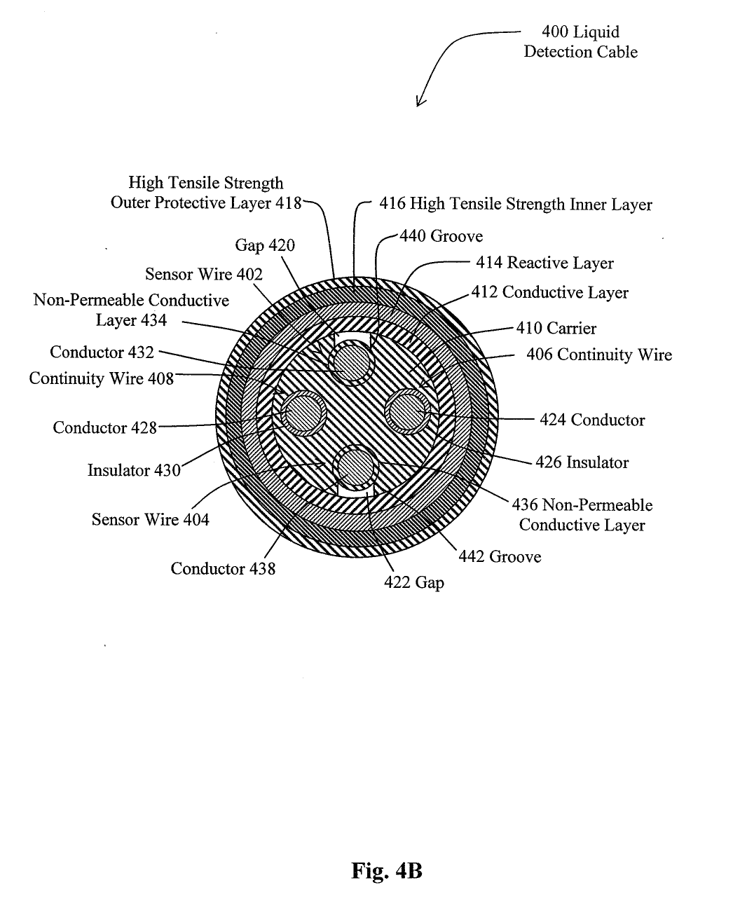

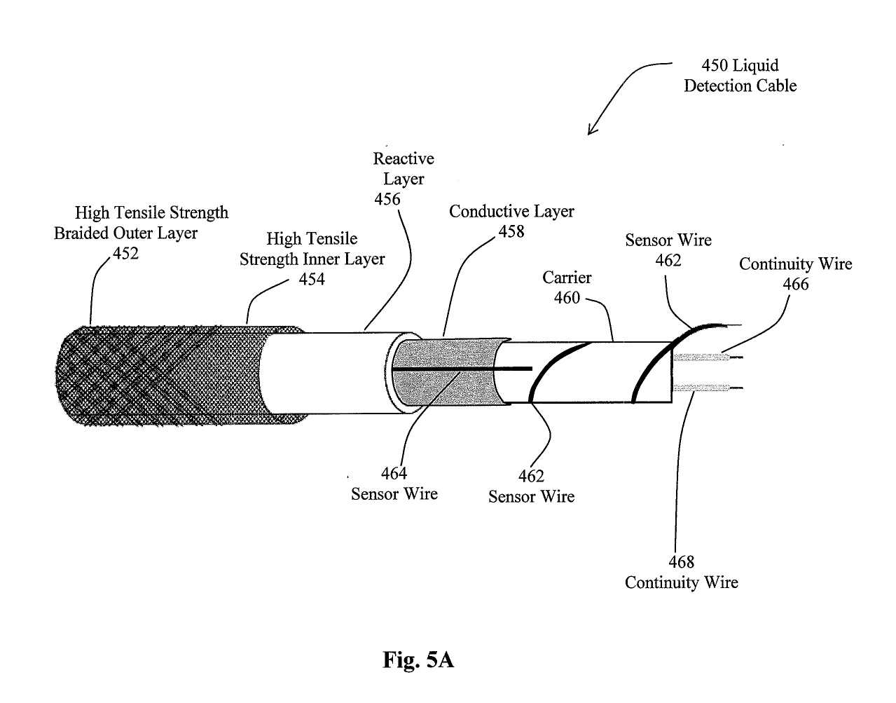

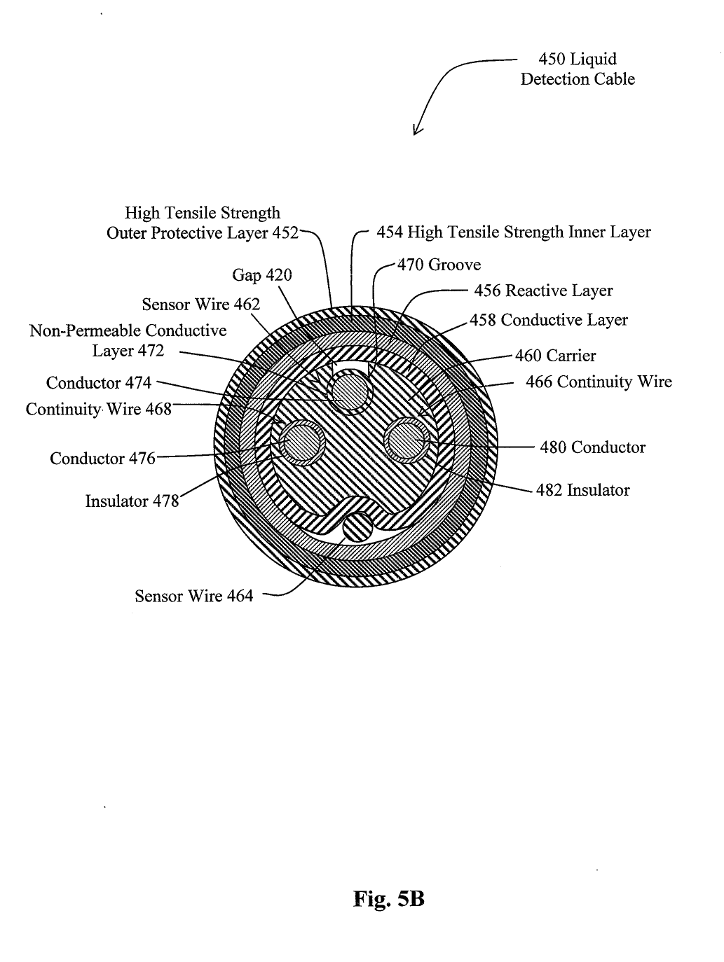

FIGS. 1A and 1B schematically illustrate one embodiment of a liquid detection cable 100. FIG. 1A is a schematic, isometric, cutaway view of the embodiment of the liquid detection cable 100. As illustrated in FIG. 1A, the liquid detection cable 100 is implemented to detect various liquids. In fact, the liquid detection cable 100 can detect the presence of any liquid by selecting a reactive layer 104 that expands in the presence of a liquid. The same is also true for the reactive layers 156, 414 and 456, illustrated in FIGS. 2A and 4A, respectively. For example, materials that can be used for reactive layers 104, 156 and 456 can detect the presence of liquid petrochemicals, liquid oleo chemicals and liquid organic chemicals, as explained in more detail below. Other implementations of the cable 100 and cable 400 can be employed to detect other liquids. Liquid detection cable 100 has an inner braided layer 102 that is surrounded by an outer braided layer 101. As used herein, the term “layer” may comprise a sheath, a covering, a wrap, a coating, a braid, wound tape, or other structures, and does not necessarily have to fully surround or enclose another layer. In that regard, the term “surround” and “surrounding” does not mean that a layer is fully enclosed or encapsulated, but may be only partially covered. The inner braided layer 102 is made of nylon, plastic or other materials that are resistant to the liquid chemical being detected. For example, inner braided layer 102 may be constructed to be resistant to solvents and other hydrocarbon-based liquid chemicals. The inner braided layer 102 forms a sheath of braided strands of a resistant material that is substantially unaffected by most petrochemicals, organic chemicals and solvents. The strands have a diameter on the order of 10 mils and have a denier of approximately 150 (S glass fibrons). The strands fit tightly around the reactive layer 104. The inner braided layer 102 is capable of substantially maintaining its diameter in the presence of expansive forces of the reactive layer 104. The strands of the inner braided layer 102 are tightly woven and are made of a material that does not substantially expand or stretch in response to pressures generated by reactive layer 104. In that regard, the inner braided layer 102 is capable of substantially maintaining a predetermined diameter when subjected to such pressures in the presence of liquids, including petrochemicals, solvents and other liquid organic chemicals, depending upon the reactive layer 104 utilized in the liquid detection cable 100. As such, the inner braided layer 102, as well as inner braided layer 154 (FIG. 2A), high tensile strength inner layer 416 (FIG. 4A) and high tensile strength inner layer 454 (FIG. 5A) are considered to be constricting layers that constrict expansion of reactive layers in an outward direction. Outer braided layer 101 has a larger weave than the inner braided layer 102 and is constructed of larger diameter strands that are less likely to fray, which protects inner braided layer 102. The outer braided layer 101 is constructed to allow the liquid detection cable 100 to be pulled and dragged over rough surfaces with little or no damage to the inner braided layer 102.

As also illustrated in FIG. 1A, the inner braided layer 102 surrounds reactive layer 104. Reactive layer 104 is made from a material that is hydrophobic, but can be selected to absorb petrochemicals, solvents and many hydrocarbon liquid chemicals, liquid oleo-chemicals, such as plant based oils, and/or liquid organic chemicals, which cause the reactive layer 104 to expand and swell. For example, a reactive layer 104 can be selected that expands and swells in the presence of most petrochemicals, as well as solvents, such as toluene, dichloromethane, tricholorethylene, trichlorethane, methylethylketone, acetone, N-methylpyrrolidone and isopropyl alcohol. Other liquid hydrocarbons and other chemicals may also be absorbed by the reactive layer 104 and cause the reactive layer 104 to expand. The material of the reactive layer 104 can be a plastic material that is an electrically insulating material. Various plastic materials can be used, including olefin polymers, thermoplastic elastomers (TPE) and thermoplastic rubber (TPR), including nitrils and SEBS materials. For example, a non-conductive, thermoplastic elastomer alloy of styrenic and olefinic elastomer, olefinic resins, inorganic filler and process oils can be used as the reactive layer 104. In addition, the reactive layer 104 may use organics, aromatics and aliphatic materials.

Other chemical detection cables, such as the chemical detection cable disclosed in U.S. Pat. No. 4,926,165, which is specifically incorporated herein by reference for all that is discloses and teaches, utilizes a reactive layer that is doped with a conductive material to render the reactive layer conductive. These conductive dopants, such as carbon, do not expand in the presence of chemicals. As a result, the amount and speed at which the reactive layer expands is reduced exponentially, as the amount of the conductive dopant is added to the reactive layer. In that regard, a significant amount of dopant is required to render the reactive layer conductive. For example, amounts of up to fifty percent or more of carbon may be added to the reactive layer in existing chemical detection cables, such as disclosed in U.S. Pat. No. 4,926,165, to obtain sufficient conductivity of the reactive layer.

The reactive layer 104, illustrated in FIG. 1A, expands significantly faster and to a greater extent than existing reactive layers that are doped with conductive materials, such as disclosed in U.S. Pat. No. 4,926,165. In addition, the reactive layer 104 is constructed to have greater wall thickness than existing reactive layers, which also creates faster and greater expansion of the reactive layer 104. Testing of the reactive layer 104, which does not include any conductive dopants, has provided the unexpected result of expansion rates that are approximately 10 times faster than the expansion rates of reactive layers doped with conductive materials, such as disclosed in U.S. Pat. No. 4,926,165.

As also illustrated in FIG. 1, the reactive layer 104 surrounds a conductive layer 106. The conductive layer 106 may be made from conductive polyvinylchloride (PVC), a conductive polyolefin, a conductive fluoropolymer, or other conductive plastic or plastic-like material. For example, polytetrafluoroethylene (Teflon®) can be used as conductive layer 106. In addition, other conductive materials can be utilized, such as polyesters, ionemers, polymers/plastics, copolymers and homopolymers (plastics). Conductive layer 106 can also be made from a malleable metal that can be deformed and pressed inwardly by the reactive layer 104, as the reactive layer 104 expands. Adherence between the reactive layer 104 and the conductive layer 106 is desirable for the construction and operation of the detection cable 100.

As also illustrated in FIG. 1A, the conductive layer 106 surrounds an insulating braided binder 108. The insulating braided binder 108 is made from a braided material that is braided to allow sufficient interstitial spaces between the braided material and the conductive layer 106 to allow the conductive layer 106 to move through the interstitial openings when pressure is applied to the conductive layer 106 by reactive layer 104, while simultaneously providing an insulating layer when lesser pressures are applied to the conductive layer 106, such as a person stepping on the cable 100. In one embodiment, the braided binder is constructed of glass braid or any number of materials, such as polyester, nylon, plastic, glass or fabric (natural or synthetic), having a strand groupings diameter of approximately >2 mils and preferably about 5 mils, and is braided so that only forty percent of the surface of the conductive layer 106 is covered by the braid. As such, sixty percent of the inside surface of the conductive layer 106 is exposed. The binder functions as a thatched separator to keep the conductor 128 and conductive layer 130, as well as the conductor 138 and conductive layer 136, from touching the conductive layer 106 when the liquid detection cable 100 is bent or flexed, or weight is applied, such as by a human step, on the liquid detection cable 100. When a chemical is detected, the conductive layer 106 contracts and squeezes through the thatching or braiding of the insulating binder 108 to cause electrical conduction between the conductive layer 130 and conductive layer 136 and the conductive layer 106. In accordance with this embodiment, the insulating braided binder 108 has a thickness of approximately 10 mm. Of course, other thicknesses and other percentages of coverage can be used, depending upon the type of material used for the insulating braided binder 108 and the conductive layer 106. In addition, the insulating braided binder 108 may comprise a layer of insulating material that has openings, or interstitial openings, that allow conductive layer 106 to move through these interstitial openings. As such, either braided materials, or a layer with openings, can be used as a binder layer 108, 162 (FIG. 2A).

As also illustrated in FIG. 1A, the insulating braided binder 108 surrounds spacers 114, 118, sensor wires 110, 112 and continuity wires 116, 120. The spacers 114, 118 are made from a non-conducting material. Sensor wires 110, 112 have a smaller diameter than the spacers 114, 118 and, as such, are recessed from the insulating braided binder 108 and the conductive layer 106. Similarly, the continuity wires 116, 120 have an outer insulating layer and are approximately the same diameter as the spacers 114, 118. Continuity wires 116, 120 provide a return path for the sensor wires 110, 112 at the end of the cable. Spacers 114, 118 can be made simply of an insulating material, or they can constitute an insulated wire, such as continuity wires 116, 120, which can provide other information, such as communications data, or a redundant return path for the continuity wires 116, 120. While spacers 114, 118 and continuity wires 116, 120 all have an insulating outer surface, the sensor wires 110, 112 have an outer layer that is conductive and capable of carrying current, as explained in more detail below. The spacers 114, 118, continuity wires 116, 120, and sensor wires 110, 112 are all spirally wrapped around a center wire 122. Center wire 122 has an outer insulator 126 and a center wire conductor 124. The center wire 122 provides stability to the overall structure. The center wire conductor 124 can also be used for various purposes, including carrying power, data or other information. Of course, other structures can be used to provide stability to the liquid detection cable 100.

As also shown in FIG. 1A, the sensor wires 110, 112 are disposed between the spacers 114, 118, so that when sensor wires 110, 112 are twisted in a spiral, the spacers 114, 118 prevent the sensor wires 110, 112 from touching. As indicated above, the insulating braided binder 108 provides an insulating layer between the conductive layer 106 and the sensor wires 110, 112. If the liquid detection cable 100 is stepped on, the insulating braided binder 108 prevents the conductive layer 106 from contacting the sensor wires 110, 112. In that regard, the force of an individual stepping on the liquid detection cable 100 is spread by the insulating braided binder 108 across the surface of the conductive layer 106, so that the conductive layer 106 does not protrude through the insulating braided binder 108 and contact the sensor wires 110, 112. The higher, more concentrated forces created by the expansion of the reactive layer 104 on the conductive layer 106, cause the conductive layer 106 to penetrate through the openings in the insulating braided binder 108 and create a conductive path between sensor wire 110 and sensor wire 112.

FIG. 1B is an end view of the liquid detection cable 100. As shown in FIG. 1B, the outer braided layer 101 covers the inner braided layer 102. Again, the outer braided layer 101 has coarser fibers that protect the finer inner braided layer 102. The inner braided layer 102 has smaller diameter fibers that are capable of maintaining the size of the inner braided layer 102, which fits snugly around the reactive layer 104. As illustrated in FIG. 1B, the conductive layer 106 surrounds the insulating braided binder 108. The insulating braided binder 108 holds the sensor wires 110, 112, continuity wires 116, 120 and spacers 114, 118, that are twisted around the center wire 122, in close conformity to the center wire 122. In other words, the insulating braided binder 108 assists in providing a sound structure of twisted cables, wires and spacers around the center wire 122 and assists in preventing the sensor wires 110, 112, spacers 114, 118 and continuity wires 116, 120 from becoming unraveled.

As also illustrated in FIG. 1B, sensor wire 110 has a conductive layer 136 and a conductor 138 disposed within the conductive layer 136. The conductive layer 136 may be made from a polymer or other plastic material that is doped with a conductive material, such as carbon. The conductive layer 136 is in electrical contact with the conductor 138. Similarly, sensor wire 112 has a conductive layer 130 that surrounds a conductor 128. Conductive layer 130 may also be made from a polymer or plastic that is doped with a conductive material, such as carbon or other conductive material so that the conductive layer 130 is conductive and in electrical contact with conductor 128. Continuity wire 116 has an insulating layer 146 that surrounds a conductor 144. Similarly, continuity wire 120 has an insulating layer 132 that is surrounded by a conductor 134. The conductive layers 130, 136 protect the conductors 128, 138 from chemicals that may attack or cause corrosion to the conductors 128, 138. Conductive layers 130, 136 provide a conductive medium while still protecting conductors 128, 138 from damage that may be caused by liquid petrochemicals and other corrosive materials that may penetrate the liquid detection cable 100. Insulating layers 132, 146 protect conductors 134, 144, respectively, from damage that may be caused by exposure of the liquid detection cable 100 to certain types of chemicals. Similarly, insulator 142 protects conductor 140 of center wire 122.

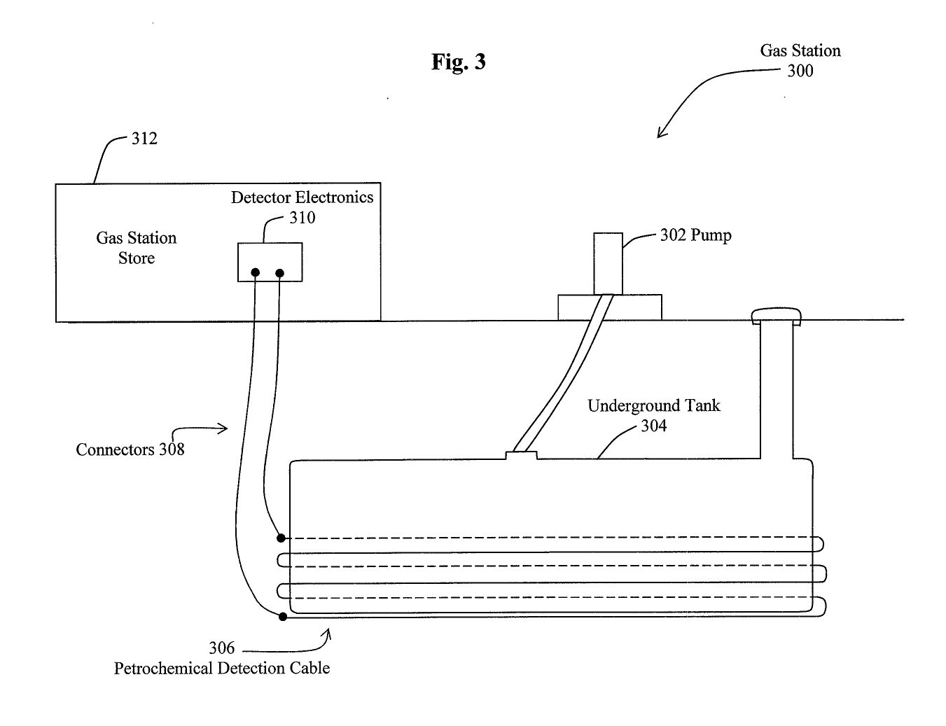

In operation, the liquid detection cable 100, disclosed in FIGS. 1A and 1B, is disposed in a location in which liquid detection cable 100 is contacted by a liquid. The liquid flows through the outer braided layer 101 and through inner braided layer 102 onto the reactive layer 104. The reactive layer 104 absorbs the liquid, expands and swells in the presence in the liquid. As the reactive layer 104 expands and swells, it generates a force on both the inner braided layer 102 and the conductive layer 106. The inner braided layer 102, as set forth above, is made from a material that does not substantially expand and, as such, maintains a substantially consistent diameter. The force of the expanded reactive layer 104 is directed inwardly toward the conductive layer 106. The conductive layer 106 is driven inwardly by the force generated by the reactive layer 104 toward the center of the liquid detection cable 100. The force of the reactive layer 104 causes the insulating braided binder 108 to move inwardly toward sensor wires 110, 112. The force further causes the conductive layer 106 to protrude through the openings in the insulating braided binder 108 and make electrical contact with the conductive layer and sensor wires 110, 112. An electrical connection is then formed between sensor wire 110 and sensor wire 112 at the location of the exposure of the liquid detection cable 100 to the liquid. The detector electronics 310, illustrated in FIG. 3, then detects the existence and location of the liquid on the liquid detection cable 100, such as the location of a leak using time domain reflectometry.

FIG. 2A is a schematic, perspective, cutaway view of an embodiment of a liquid detection cable 150. As illustrated in FIG. 2A, the liquid detection cable 150 is implemented to detect various liquids, such as the liquids disclosed with respect to the description of FIG. 1A. Liquid detection cable 150 has an inner braided layer 154 that is surrounded by an outer braided layer 152. These layers can be made of the same materials, and in the same manner, as inner braided layer 102 and outer braided layer 101, illustrated in FIG. 1A. As such, these layers may be resistant to various liquids, in the same manner as disclosed above with respect to FIGS. 1A and 1B. In addition, these layers can be made from strands that are the same size as the strands described with respect to FIGS. 1A and 1B. The inner braided layer 154 is capable of substantially maintaining its diameter in the presence of expansive forces created by reactive layer 156. The strands of the inner braided layer 154 are tightly woven and made of a material that does not substantially expand or stretch in response to pressures generated by reactive layer 156. Outer braided layer 152 has a larger weave than the inner braided layer 154 and is constructed of larger diameter strands that are less likely to fray, so as to protect the inner braided layer 154. The outer braided layer 152 is constructed to allow the liquid detection cable 150 to be pulled and dragged over rough surfaces with little or no damage to the inner braided layer 154.

The reactive layer 156, illustrated in FIG. 2A, is hydrophobic, but absorbs various other liquids, such as petrochemicals, oleo chemicals, such as plant based oils, and liquid organic chemicals. The same materials can be used for the reactive layer 156 that are disclosed with respect to the reactive layer 104 of FIGS. 1A and 1B.

The reactive layer 156, that is disclosed in FIG. 2A, does not contain conductive dopants and, as such, expands exponentially faster than reactive layers that are used in other liquid detection cables that contain conductive dopants.

As also illustrated in FIG. 2A, the reactive layer 156 surrounds a conductive layer 160. The conductive layer 160 may be made from conductive polyvinylchloride (PVC), a conductive polyolefin, a conductive fluoropolymer, or other conductive plastic or plastic-like material. The conductive layer 160 can be constructed of materials that are the same as that disclosed for conductive layer 106, as disclosed with respect to FIG. 1A. As also illustrated in FIG. 2A, sensor conductor 158 is disposed between the reactive layer 156 and the conductive layer 160. The reactive layer 156 holds the sensor conductive 158 tightly against the conductive layer 160 to ensure conduction between the sensor conductor 158 and the conductive layer 160. In this manner, a conductive path is created between the conductive layer 160 and the sensor conductor 158 throughout the length of the conductive layer 160. Sensor conductor 158 has less resistance than the conductive layer 160 and is capable of carrying a sensor signal throughout the length of the liquid detection cable 150.

As also illustrated in FIG. 2A, the conductive layer 160 surrounds an insulating braided binder 162. The insulating braided binder 162 is made from a braided material that is braided to allow sufficient interstitial spaces between the braided material and the conductive layer 160 to allow the conductive layer 160 to move through the interstitial openings when pressure is applied to the conductive layer 160 by the reactive layer 156, while simultaneously providing an insulating layer when lesser pressures are applied to the conductive layer 160, such as a person stepping on the liquid detection cable 150. The insulating braided binder 162 can be made from the same materials as the insulated braided binder 108 that is described with respect to FIG. 1A. The interaction of the conductive layer 160 and the insulating braided binder 162 is the same as that described with respect to conductive layer 106 and insulated braided binder 108, as disclosed with respect to FIG. 1A.

As also illustrated in FIG. 2A, the insulating braided binder 162 surrounds spacers 168, 170 that are made from a non-conducting material. A single sensor wire 166 has a smaller diameter than the spacers 168, 170 and, as such, is recessed from the insulating braided binder 162 and the conductive layer 160. Similarly, the continuity wires 164, 165 have an outer insulating layer and are approximately the same diameter of spacers 168, 170. Continuity wires 164, 165 provide a return path for the sensor wire 166 and sensor conductor 158 at the end of the liquid detection cable 150. Spacers 168, 170 can be made from an insulating material, or they can constitute an insulated wire, such as continuity wires 164, 165. While spacers 168, 170 and continuity wires 164, 165 all have an insulating outer surface, the sensor wire 166 has an outer layer that is conductive and capable of carrying current, as explained in more detail below. The spacers 168, 170, continuity wires 164, 165, and sensor wire 166, are all spirally wrapped around a center wire 171. Center wire 171 has an outer insulator 174 and a center wire conductor 172. Center wire 171 provides stability for the overall structure of the liquid detection cable 150. The center wire conductor 172 can also be used for various purposes, including carrying power, data or other information. Of course, other structures can be used to provide stability to the liquid detection cable 150.

As also shown in FIG. 2A, the sensor wire 166 is disposed between spacers 168, 170 and continuity wire 165, so that when the sensor wire 166 is twisted in a spiral, the spacers 168, 170, as well as continuity wire 165, isolate the sensor wire 166. As indicated above, the insulating braided binder 162 provides an insulating layer between the conductive layer 160 and the sensor wire 166. If the liquid detection cable 150 is stepped on, the insulating braided binder 162 prevents the conductive layer 160 from contacting the sensor wire 166. In that regard, the force of an individual stepping on the liquid detection cable 150 is spread by the insulating braided binder 162 across the surface of the conductive layer 160, so that the conductive layer 160 does not protrude through the insulating braided binder 162 and contact the sensor wire 166. A higher, more concentrated force, created by the expansion of the reactive layer 156 on the conductive layer 160, causes the conductive layer 160 to penetrate through the interstitial openings in the insulating braided binder 162 and create a conductive path between the sensor wire 166 and the sensor conductor 158, which is in electrical contact with the conductive layer 160.

FIG. 2B is an end view of the embodiment of the liquid detection cable illustrated in FIG. 2A. As shown in FIG. 2B, the outer braided layer 152 covers the inner braided layer 154. Again, the outer braided layer 152 has coarser fibers that protect the finer inner braided layer 154. The inner braided layer 154 has smaller diameter fibers that are capable of maintaining the size of the inner braided layer 154, which fits snuggly around the reactive layer 156. As illustrated in FIG. 2B, the conductive layer 160 surrounds the insulating braided binder 162. The insulating braided binder 162 holds the sensor wire 166, continuity wires 164, 165 and spacers 168, 170, that are twisted around the center wire 171, and assists in preventing the sensor wire 166, spacers 168, 170, and continuity wires 164, 165, from becoming unraveled. As also illustrated in FIG. 2B, sensor wire 166 comprises a bare conductor. Sensor wire 166 has a smaller diameter than the spacers 168, 170 and continuity wires 164, 165, so that a gap 192 is created between the insulating braided binder 162 and the sensor wire 166. Sensor conductor 158 is shown to be in contact with conductive layer 160 and reactive layer 156. As disclosed above, the reactive layer 156 forces the sensor conductor 158 to be in electrical contact with the conductive layer 160.

As also illustrated in FIG. 2B, continuity wire 164 has an insulating layer 188 that surrounds a conductor 190. Similarly, continuity wire 165 has an insulating layer 182 that surrounds a conductor 180. The insulating layers 188, 182 provide protection to the conductors 190, 180, respectively. Center wire 171 has an insulator 186 that protects conductor 184. Reactive layer 156 also provides protection for sensor wire 166, sensor conductor 158 and center wire 171.

In operation, the liquid detection cable 150, disclosed in FIGS. 2A and 2B, is disposed in a location in which the liquid detection cable 150 is contacted by a liquid to be detected. The liquid flows through the outer braided layer 152 and through the inner braided layer 154 onto the reactive layer 156. The reactive layer 156 absorbs the liquid, expands and swells in the presence of the liquid. As the reactive layer 156 expands and swells, it generates a force on both the inner braided layer 154 and the conductive layer 160. The inner braided layer 154, as set forth above, is made from a material that does not substantially expand and, as such, maintains a substantially consistent diameter. The force of the expanded reactive layer 156 is directed inwardly toward the conductive layer 160. The conductive layer 160 is driven inwardly by the force generated by the reactive layer 156 toward the center of the liquid detection cable 150. The force of the reactive layer 156 causes the insulating braided binder 162 to move inwardly toward sensor wire 166 and eliminate gap 192. The force further causes the conductive layer 160 to protrude through the interstitial openings in the insulating braided binder 162 and make electrical contact with the sensor wire 166. An electrical connection is then formed between the sensor conductor 158, which is in electrical contact with the conductive layer 160, and sensor wire 166 at the location of the exposure of the liquid detection cable 150 to the liquid being detected. Detector electronics 310, illustrated in FIG. 3, then detects the existence and location of the liquid on the liquid detection cable 150, such as the location of a leak using time domain reflectometry.

FIG. 3 is a schematic illustration of an embodiment of an application for detecting the presence of petrochemical liquids leaking from an underground tank at a gas station 300. As shown in FIG. 3, an underground tank 304 is connected to pump 302 at the gas station 300. The underground tank 304 is surrounded by a petrochemical detection cable 306 on both side portions of the underground tank 304, and bottom portions underneath the underground tank 304. The petrochemical detection cable 306 is connected by connectors 308 to detector electronics 310 disposed in the gas station store 312. Whenever gasoline, diesel fuel or other petrochemicals are detected from the underground tank 304, the detector electronics 310 detects the presence of the petrochemical, and may sound an alarm, indicating the detection of leakage of petrochemicals from the underground tank 304.

In this manner, the structural integrity of the underground tank 304 can be monitored so that environmental hazards do not occur as a result of leakage of gasoline, diesel, or other petrochemicals, or organic chemicals from the underground tank 304, over an extended period of time. It should be noted that there are various applications for liquid detection cables and FIG. 3 discloses only a single application. In addition, the liquid detection cable 100 can be utilized not only for detecting leaks, but for detecting the presence of liquids and the location of those liquids along the length of the liquid detection cable 100, for various other purposes.

FIG. 4A is a schematic isometric view of another embodiment of a liquid detection cable 400. As shown in FIG. 4A, the liquid detection cable 400 includes a high tensile strength braided outer layer 418. The high tensile strength braided outer layer 418 is made from a very high tensile strength Teflon material, or similar material, that can have a tensile strength on the order of 9,000 pounds. The high tensile strength braided outer layer 418 is braided in a manner so that large openings, on the order of 2 mm, are formed between the braid of the high tensile strength strands. In this manner, liquids can easily move through the high tensile strength braided outer layer 418. The high tensile strength braided outer layer 418 is braided in a manner that provides as much as 200 pounds of pull strength to the chemical detection cable 400. As such, large forces can be applied to the high tensile strength braided outer layer 418 to pull the liquid detection cable 400 through openings and tight areas during installation. The strands of the high tensile strength braided outer layer 418 can be made from Teflon or other material that not only has a high tensile strength, but also provides a slippery surface that allows the chemical detection cable 400 to be more easily pulled through tight areas without damaging the chemical detection cable 400. For example, the high tensile strength braided outer layer 418 may be constructed from Teflon coated yarn available from W. F. Lake Corp., 65 Park Road, P.O. Box 4214, Glens Falls, N.Y., 12804. The same materials can be used for high tensile strength braided outer layer 418 as outer braided layer 101, illustrated in FIG. 1A.

As also illustrated in FIG. 4A, the high tensile strength braided outer layer 418 surrounds and protects a high tensile strength inner layer 416. The high tensile strength braided outer layer 418 is constructed of larger diameter strands that are less likely to fray than the smaller diameter strands of the high tensile strength inner layer 416. In this manner, the high tensile strength braided outer layer 418 is better able to protect the high tensile strength inner layer 416. The high tensile strength inner layer 416 is a thicker layer of material that uses finer strands in a tight weave pattern than the high tensile strength braided outer layer 418, but may also be made from a Teflon material, or similar material, that is formed in a braid or mesh. The braid or mesh allows chemicals to move through the high tensile strength inner layer 416 to the reactive layer 414. The high tensile strength inner layer 416 can also be made from a material such as Teflon, or similar material, which may have a tensile strength on the order of several thousand pounds. For example, ETFE (Tefzel) filaments can be used, which are available from Pelican Wire Company, Inc., 3650 Shaw Boulevard, Naples, Fla., 34117-8408. Also, the high tensile strength inner layer 416 can be constructed in the same manner and use the same materials as the inner braided layer 102, illustrated in FIG. 1A. The high tensile strength inner layer 416 is braided in a manner that the inner layer maintains the outer diameter of the reactive layer 414 as it swells in the presence of chemicals. A tighter weave can be used with the smaller diameter high tensile strength strands of the high tensile strength inner layer 416, which provides a greater ability to constrict expansion. The mesh or weave of high tensile strength inner layer 416 has a tensile strength and a mesh or weave pattern so that forces created by the reactive layer 414, when the reactive layer 414 swells in the presence of liquids, do not allow the reactive layer 414 to expand outwardly. In this manner, the high tensile strength inner layer 416 is capable of substantially maintaining its diameter in the presence of the expansive forces of the reactive layer 414. The strands of the high tensile strength inner layer 416 are tightly woven and made of a material that does not substantially expand or stretch in response to the pressures generated by the reactive layer 414. As such, the high tensile strength inner layer 416 does not expand, and holds the outer diameter of the reactive layer 414 at a diameter that substantially coincides with the inner diameter of the high tensile strength inner layer 416, which constrains the reactive layer and causes the reactive layer 414 to expand inwardly. Accordingly, the high tensile strength inner layer 416 functions as a constricting layer. Both the high tensile strength braided outer layer 418 and the high tensile strength inner layer 416 can be made from materials that are not braided, such as a layer that has openings formed in the layer. Of course, the same is true for outer braided layer 101 and inner braided layer 102, illustrated in FIG. 1A, outer braided layer 152 and inner braided layer 154 of FIG. 2A, and high tensile strength braided outer layer 452 and high tensile strength inner layer 454, illustrated in FIG. 5A.

The reactive layer 414, illustrated in FIG. 4A, is made from a material that swells in the presence of a chemical. Reactive layer 414 is made from a material that is hydrophobic, but can be selected to absorb petrochemicals, solvents, and many hydrocarbon liquid chemicals, liquid oleo chemicals, such as plant based oils, and/or liquid organic chemicals. In one embodiment, petro-reactive compounds can include a nitril blend that is available from S&E Specialty Polymers, 140 Leominster-Shirley Road, Lunenburg, Mass., 01462. Other materials can be used for the reactive layer 414 to detect the presence of other liquid chemicals, as set forth below. The hydrophobic nature of the reactive layer 414 prevents the reactive layer 414 from absorbing water, so that the liquid detection cable 400 does not activate in the presence of water. The reactive layer 414 can be made from the same materials as the reactive layer 104 described with respect to FIG. 1A.

The conductive layer 412, illustrated in FIG. 4A, can be made from a plastic material that is combined with a conductive material, such as carbon or other small particle conductive material. For example, conductive PVC may be used, having both standard and soft durometer, such as that sold by Teknor Apex Company, 505 Central Avenue, Pawtucket, R.I., 02861. In addition, conductive layer 412 can be made in the same way and from the same materials as reactive layers 104, 156, 456 to detect the same chemicals as liquid detection cables 100, 150, 450.

Carrier 410 of the chemical detection cable 400, illustrated in FIG. 4, is made from a thermoplastic elastomer, or other plastic, which is non-conductive and flexible. Carrier 410 has two grooves, formed in a spiral shape around the outer surface of the carrier 410 in which the sensor wires 402, 404 are disposed. The grooves can be formed during extrusion of carrier 410, or after extrusion. The grooves are sufficiently deep that the sensor wires 402, 404 are displaced below the surface of the carrier 410 by a predetermined amount. As such, gaps 420, 422 (FIG. 4B) exist between the surface of the sensor wires 402, 404, and the outer surface of the carrier 410. In the process of manufacturing, the sensor wires 402, 404 are pulled and twisted into the grooves 440, 442 in the carrier 410. The grooves 440, 442 are sufficiently small and the thermoplastic elastomer of the carrier 410 is sufficiently flexible to hold the sensor wires 402, 404 in place in the carrier 410. Since the sensor wires 402, 404 are pulled into the grooves 440, 442, the tension on the sensor wires 402, 404, as well as the forces from the conductive carrier 410, cause the sensor wires 402, 404 to be disposed in and remain situated at the innermost portion of grooves 440, 442 to create and maintain gaps 420, 422 (FIG. 5). Continuity wires 406, 408 are disposed in the carrier 410 during the extrusion process of the carrier 410. Cross die extrusion processes may be used to create the carrier 410 and extrude the carrier 410 with the continuity wires 406, 408.

FIG. 4B is a cross-sectional view of the embodiment of the liquid detection cable 400, illustrated in FIG. 4A. As shown in FIG. 4B, the high tensile strength braided outer layer 418 surrounds the high tensile strength inner layer 416. A reactive layer 414 is surrounded by the high tensile strength inner layer 416. The inner diameter of the high tensile strength inner layer 416 holds the outer diameter of the reactive layer 414 so that the reactive layer 414 cannot expand outwardly and, as such, is considered to be a constricting layer. The reactive layer 414 surrounds a conductive layer 412. As indicated above, the conductive layer 412 is made from a conductive malleable material. Conductive layer 412 can be constructed from the same materials and in the same manner as conductive layer 106. The conductive layer 412 surrounds the carrier 410. The carrier 410 is extruded with continuity wires 406, 408, so that the continuity wires 406, 408 are disposed within the carrier 410. The continuity wires 406, 408 include a conductor 424, 428, respectively, which is surrounded by insulators 426, 430, respectively. The insulators 426, 430 are made from a material that is different from the material of the carrier 410. The material of the insulators 426, 430 is a material that has low adhesion with the material of the carrier 410. In that manner, it is easier to strip the carrier 410 from the insulators 430, 426 of the continuity wires 408, 406, respectively. Sensor wires 402, 404 include conductors 432, 438. Conductors 432, 438 are surrounded by a non-permeable conductive layer 434, 436. The non-permeable conductive layer is impervious to petrochemicals and other potentially corrosive and damaging liquids, which protects the conductors 432, 438. The non-permeable conductive layers 434, 436 are capable of transmitting an electrical current to the conductors 432, 438. The non-permeable conductive layers 434, 436 may be a conductive polyolefin or a conductive polyethylene. The conductive polyolefin or conductive polyethylene are available from Breen Color Concentrates, 11 Kari Drive, Lambertville, N.J., 08530.

As illustrated in FIG. 4B, gaps 420, 422 that are adjacent to sensor wires 402, 404 prevent conduction between the conductive layer 412 and each of the sensor wires 402, 404. However, when a liquid seeps through the high tensile strength braided outer layer 418 and the high tensile strength inner layer 416 to the reactive layer 414, the reactive layer 414 swells. The high tensile strength braided outer layer 418 and high tensile strength inner layer 416 do not allow outward expansion of the reactive layer 414. Hence, the reactive layer 414 expands inwardly, as shown in FIG. 4B. The forces created by the inward expansion of the reactive layer 414 are transmitted to the conductive layer 412. The conductive layer 412 may be constructed from a somewhat malleable, soft durometer material, which allows the conductive layer 412 to expand into gaps 420, 422, so that the conductive layer 412 contacts the non-permeable conductive layer 434 of sensor wire 402 and the non-permeable conductive layer 436 of sensor wire 404. Both standard and soft durometer conductive PVC is available from Teknor Apex Company, 505 Central Avenue, Pawtucket, R.I., 02861. In addition, the conductive layer 412 can be made from the same materials and in the same manner as conductive layer 106, as disclosed above. In this manner, a conductive path is created between sensor wire 402 and sensor wire 404 at a location where the chemical is present and permeates the liquid detection cable 400. Continuity wires 406, 408 provide continuity information, while sensor wires 402, 404 can be used to detect the location of the leak using time domain reflectometry techniques.

The structure illustrated in FIGS. 4A and 4B can also be used to detect other types of liquids. The same structure can be used, as illustrated in FIGS. 4A and 4B, with the reactive layer 414 replaced with a sheath of materials that are reactive to and swell in response to a particular liquid being detected by detection cable 400. For example, a nitril blend chemical-reactive compound available from S&E Specialty Polymers, 140 Leominster-Shirley Road, Lunenburg, Mass., 01462, which is reactive to many hydrocarbon-based fuels, such as gasoline, diesel, jet fuel and highly volatile petrochemicals can be replaced with an SEBS (Styrene-Ethylene/Butylene-Styrene) material that swells in the presence of hydrocarbon oils, vegetable oils and other types of oils. Similarly, the reactive layer 414 can be replaced with materials that react to and swell in the presence of volatile organic materials, alcohol, ketones, and other similar liquids. Such materials may be a polypropylene-based material, a polyolefin, or polyethylene material. Hence, the structure of the liquid detection cable 400, illustrated in FIGS. 4A and 4B, can be used to detect the presence of other liquids and gases, other than petrochemicals, by simply replacing the reactive layer 414 with a material that swells in the presence of the liquid or gas to be detected. In this manner, the overall structure of the detection cable 400 can be used in various implementations to detect various liquids or gases.

The size of the gaps 420, 422, illustrated in FIG. 4B, can be controlled with a high degree of precision based upon the manufacturing tolerances used during the construction process of the detection cable 400. Gaps 420, 422 are made sufficiently large to allow for a tight bend radius of the liquid detection cable 400. For example, bend radii of one inch have been used without creating a false detection. The size of the gaps 420, 422 also affects the sense time for sensing the presence of a liquid. For example, large gaps may increase the time for the reactive layer 414 of the embodiment of the liquid detection cable 400 to swell sufficiently to cause the conductive layer 412 to contact the non-permeable conductive layers 434, 436. In that regard, the size of the gaps 420, 422 is carefully selected to create a reliable product that reacts in a quick time period to the detection of liquids. Gaps in the range of about 10 mils to about 50 miles, but preferably in the range of about 15 miles to about 25 miles, provide such results.

FIG. 5A is a schematic, perspective, cutaway view of an embodiment of a liquid detection cable 450. As illustrated in FIG. 5A, the liquid detection cable 450 is implemented to detect various types of liquids, such as disclosed with respect to the various embodiments disclosed herein. Liquid detection cable 450 has a high tensile strength inner layer 454 that is surrounded by a high tensile strength braided outer layer 452. Both the high tensile strength braided outer layer 452 and the high tensile strength inner layer 454 can be made from the same materials and sizes of materials that are disclosed with respect to the various embodiments disclosed herein. High tensile strength inner layer 454 is capable of substantially maintaining its diameter in the presence of expansive forces created by the reactive layer 456 and, as such, is considered to be a constricting layer. The strands of the high tensile strength inner layer 454 are tightly woven and made of a material that does not substantially expand or stretch in response to pressures generated by reactive layer 456. High tensile strength braided outer layer 452 has a larger weave than the high tensile strength inner layer 454 and is constructed of larger diameter strands that are less likely to fray, which protects the high tensile strength inner layer 454. The high tensile strength braided outer layer 452 is constructed to allow the liquid detection cable 450 to be pulled and dragged over rough surfaces with little or no damage to the high tensile strength inner layer 454.

As also illustrated in FIG. 5A, the high tensile strength inner layer 454 surrounds reactive layer 456. Reactive layer 456 is made from a material that is hydrophobic, but can be selected to absorb petrochemicals, solvents and many hydrocarbon liquid chemicals, liquid oleo chemicals, such as plant based oils, and/or liquid organic chemicals, which cause the reactive layer 456 to expand and swell. For example, a material for the reactive layer 456 can be selected that expands and swells in the presence of most petrochemicals, as well as solvents, such as toluene, dichloromethane, trichloroethylene, trichloroethane, methyl ethyl ketone, acetone, N-methylpyrrolidone, and isopropyl alcohol. Other liquid hydrocarbons and other chemicals can also be absorbed by reactive layer 456 and cause reactive layer 456 to expand. The material of the reactive layer 456 can be a plastic material that is also an electrically insulating material. Various plastic materials can be used, including olefin polymers, thermoplastic elastomers (TPE), and thermoplastic rubber (TPR), including nitrils and SEBS materials. For example, a non-conductive, thermoplastic elastomer alloy of styrene and olefinic elastomer, olefinic resins, inorganic filler, and a process oil, can be used as the reactive layer 456. In addition, the reactive layer may use organics, aromatics and aliphatic materials. Since the reactive layer 456 does not include conductive dopants, reactive layer 456 has much greater expansion rates than reactive layers that include conductive dopants. Reactive layer 456 can utilize any of the materials disclosed with respect to the other embodiments disclosed herein.

As further illustrated in FIG. 5A, reactive layer 456 surrounds a conductive layer 458. Conductive layer 458 may be made from conductive polyvinylchloride (PVC), a conductive polyolefin, a conductive fluoropolymer, or other conductive plastic or plastic-like material. For example, polytetrafluoroethylene (Teflon®) can be used as a conductive layer 458. In addition, other conductive materials can be used, such as disclosed with respect to the other embodiments disclosed herein.

As also illustrated in FIG. 5A, the conductive layer 458 surrounds a carrier 460. Carrier 460 is made from a thermoplastic elastomer, or other plastic, which is non-conductive and flexible. Carrier 460 has a single groove, formed in a spiral shape around the outer surface of the carrier 460, in which the sensor wire 462 is disposed. The groove is formed during extrusion of the carrier 460, or can be formed in a subsequent process. The groove in carrier 460 is sufficiently deep that the sensor wire 462 is displaced below the surface of the carrier 460 by a predetermined amount. As such, gap 420 (FIG. 5B) exists between the surface of the sensor wire 462 and the outer surface of carrier 460. In the process of manufacturing, the sensor wire 462 is pulled and twisted into the groove 470 formed in the carrier 460. The groove 470 is sufficiently small and the thermoplastic elastomer of the carrier 460 is sufficiently flexible to hold the sensor wire 462 in place in the carrier 460. Since the sensor wire 462 is pulled into the groove 470, the tension on the sensor wire 462, as well as the forces from the conductive carrier 460, cause the sensor wire 462 to be disposed in, and remain situated at, the innermost portion of the groove 470, to create and maintain gap 420. Continuity wires 466, 468 are disposed in the carrier 460 during the extrusion process of the carrier 460. Cross die extrusion processes may be used to create the carrier 460 and extrude the carrier 460 with the continuity wires 466, 468.

A second sensor wire 464 is also illustrated in FIG. 5A. Sensor wire 464 is disposed between the reactive layer 456 and the conductive layer 458. The reactive layer 456 exerts a force on sensor wire 464, so that sensor wire 464, which is a bare conductor, is in electrical contact with the conductive layer 458, along the length of the liquid detection cable 450. In this manner, sensor wire 464 can provide a low resistance conductive path, which is in electrical contact with the conductive layer 458 along the length of the liquid detection cable 450.

FIG. 5B is a cross-sectional view of the embodiment of the liquid detection cable 450 illustrated in FIG. 5A. As shown in FIG. 5A, the high tensile strength braided outer layer 452 surrounds the high tensile strength inner layer 454. A reactive layer 456 is surrounded by the high tensile strength inner layer 454. The inner diameter of the high tensile strength inner layer 454 holds the outer diameter of the reactive layer 456 so that the reactive layer 456 cannot expand outwardly. The reactive layer 456 surrounds a conductive layer 458. As indicated above, the conductive layer 458 is made from a conductive malleable material. Conductive layer 458 can be constructed from the same materials, and in the same manner, as disclosed with respect to the other embodiments set forth herein. Conductive layer 458 surrounds carrier 460. Carrier 460 is extruded with continuity wires 466, 468, so that continuity wires 466, 468 are disposed within the carrier 460. Sensor wire 462 includes a conductor 474, which is surrounded by a non-permeable conductive layer 472. The non-permeable, conductive layer 472 is impervious to corrosive and damaging liquids and protects the conductor 474. The non-permeable conductive layer 472 is capable of transmitting an electrical signal to the conductor 474. The non-permeable conductive layer 472 may be conductive polyolefin or a conductive polyethylene. The conductive polyolefin or conductive polyethylene are available from Breen Color Concentrates, 11 Kari Drive, Lambertville, N.J., 08530. Continuity wires 466, 468 include conductors 480, 476, respectively, that are covered with insulators 482, 478, respectively. The insulators 482, 478 are made from a material that is different from the material of the carrier 460. The material of the insulators 482, 478 is a material that has low adhesion with the material of the carrier 460. In that manner, it is easier to strip the carrier 460 from the insulators 482, 478 of the continuity wires 466, 468, respectively.

As illustrated in FIG. 5B, gap 420 provides a separation between the non-permeable, conductive layer 472 of the sensor wire 462 and the conductive layer 458. However, when a liquid seeps through the high tensile strength braided outer layer 452 and the high tensile strength inner layer 454 to the reactive layer 456, the reactive layer 456 swells. The high tensile strength braided outer layer 452 and the high tensile strength inner layer 454 do not allow outward expansion of the reactive layer 456. Hence, the reactive layer 456 expands inwardly. The forces created by an inward expansion of the reactive layer 456 are transmitted to the conductive layer 458. Conductive layer 458 may be constructed from any of the malleable materials disclosed herein, which allows the conductive layer 458 to expand into gap 420, so that the conductive layer 458 contacts the non-permeable conductive layer 472 of sensor wire 462. In this manner, a conductive path is created between the sensor wire 462 and the conductive layer 458. Sensor wire 464 is a bare conductor that is in contact with conductive layer 458. Hence, an electrical connection is made between the sensor wire 464 and sensor wire 462 at the location where the liquid has seeped through the outer layers of the liquid detection cable 450. Using time domain reflectometry electronics, the location of the leak can be determined along the length of the liquid detection cable 450.

The size of the gap 420, illustrated in FIG. 5B, can be controlled with a high degree of precision based upon the manufacturing tolerances used during the construction process of the liquid detection cable 450. Gap 420 is made sufficiently large to allow for a tight bend radius of the liquid detection cable 450. For example, bend radii of one inch have been used without creating a false detection. The size of the gap 420 also affects the sense time for sensing the presence of the liquid. For example, large gaps may increase the time for the reactive layer 456 to swell sufficiently to cause the conductive layer 458 to contact the non-permeable, conductive layer 472. In that regard, the size of the gap 420 is carefully selected to create a reliable product that reacts in a quick time period to the detection of liquids. Gaps in the range of about 10 mils to about 50 mils, but preferably in the range of about 15 mils to about 25 mils, provide such results.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of forming a liquid detection cable comprising:
providing at least two sensor wires;
placing insulating spacers between said sensor wires;
surrounding said spacers with a binder layer that provides openings;
surrounding said binder layer with a conductive layer that protrudes through said openings upon application of a force on said conductive layer;
surrounding said conductive layer with a reactive layer that expands when contacted by a liquid;
surrounding said reactive layer with a constricting layer that is capable of substantially constricting outward expansion of said reactive layer which causes said reactive layer to expand inwardly and force said conductive layer to contact said at least two sensor wires to provide a conductive path between said at least two sensor wires indicating the presence of a liquid chemical.

2. The method of claim 1 further comprising:
surrounding said constricting layer with an outer layer to protect said constricting layer.

3. The method of claim 1 wherein said process of surrounding said binder layer with a conductive layer comprises:
surrounding said binder layer with a conductive layer made from conductive PVC.

4. The method of claim 1 wherein said process of surrounding said binder layer with a conductive layer comprises:
surrounding said binder layer with a conductive layer made from conductive polytetrafluorethylene.

5. The method of claim 1 wherein said process of surrounding said binder layer with a conductive layer comprises:
surrounding said binder layer with a conductive layer made from conductive plastic.

6. The method of claim 5 further comprising:
placing continuity wires proximate to said at least two sensor wires and said spacers.

7. The method of claim 5 wherein said process of placing insulating spacers between said sensor wires further comprises:
placing insulating spacers having continuity wires between said sensor wires.

8. The method of claim 7 further comprising:
providing an insulated center wire that is surrounded by said insulating spacers and said sensor wires.

9. A method of forming a liquid detection cable comprising:
providing a first sensor wire and a second sensor wire;
surrounding said first sensor wire with a binder layer that provides openings;
surrounding said binder layer with a conductive layer that protrudes through said openings upon application of a force to said conductive layer;
surrounding said conductive layer with a reactive layer that expands when contacted by a liquid;
disposing said second sensor wire between said conductive layer and said reactive layer so that said second sensor wire is in electrical contact with said conductive layer;
surrounding said reactive layer with a constricting layer that substantially constricts outward expansion of said reactive layer, causing said reactive layer to expand inwardly and force said conductive layer to be in electrical contact with said second sensor wire and force said conductive layer to protrude through said openings in said binder layer and contact said first sensor wire so that an electrical connection is made by said conductive layer between said first sensor wire and said second sensor wire.

10. A liquid detection cable comprising:
at least two sensor wires;
spacers disposed between said sensor wires;
a nonconductive binder layer that is disposed around said spacers and said at least two sensor wires, said non-conductive binder layer having openings;
a conductive layer disposed around said nonconductive binder layer that protrudes through said openings upon application of a force on said conductive layer that is greater than a predetermined force;
a reactive layer that is disposed around said conductive layer that expands when contacted by a liquid;
a constricting layer surrounding said reactive layer that substantially constricts outward expansion of said reactive layer which causes said reactive layer to expand inwardly and generate a force on said conductive layer that is greater than said predetermined force so that said conductive layer contacts said at least two sensor wires to provide a conductive path between said at least two sensor wires indicating that said liquid is in the presence of said liquid detection cable.

11. The liquid detection cable of claim 10 further comprising:
an outer layer that surrounds and protects said constricting layer.

12. The liquid detection cable of claim 10 wherein said conductive layer comprises conductive polyvinylchloride.

13. The liquid detection cable of claim 10 wherein said conductive layer comprises conductive polytetrafluoroethylene.

14. The liquid detection cable of claim 10 wherein said conductive layer comprises conductive plastic.

15. The liquid detection cable of claim 10 further comprising:
continuity wires disposed proximate to said sensor wires and said spacers.

16. The liquid detection cable of claim 10 wherein said spacers include continuity wires.

17. The liquid detection cable of claim 10 further comprising:
an insulated center wire that is spirally wrapped with said sensor wires and said spacers.

18. A liquid detection cable comprising:
a first sensor wire;
a second sensor wire;
a non-conductive binder layer that is disposed around said first sensor wire, said non-conductive binder layer having openings;
a conductive layer disposed around said non-conductive binder layer that protrudes through said openings upon application of a force on said conductive layer that is greater than a predetermined force;
a reactive layer that is disposed around said conductive layer that expands when contacted by a liquid;
a second sensor wire disposed between said conductive layer and said reactive layer so that said second sensor wire is in electrical contact with said conductive layer;
a constricting layer surrounding said reactive layer that substantially constricts outward expansion of said reactive layer, causing said reactive layer to expand inwardly and force said conductive layer to be in electrical contact with said sensor wire and force said conductive layer to protrude through said openings in said binder layer and contact said first sensor wire so that an electrical connection is made by said conductive layer between said first sensor wire and said second sensor wire.

19. A method of making a liquid detection cable comprising:
providing at least two sensor wires;
placing said sensor wires in grooves in a carrier so that gaps are created between an outside surface of said carrier and said sensor wires;
surrounding said carrier and said sensor wires with a conductive layer that protrudes into said gaps upon application of a force on said conductive layer;
surrounding said conductive layer with a reactive layer that expands when contacted by a liquid;
surrounding said reactive layer with a constricting layer that is capable of substantially constricting outward expansion of said reactive layer which causes said reactive layer to expand inwardly and force said conductive layer into said gaps to contact said at least two sensor wires to provide a conductive path between said at least two sensor wires indicating the presence of a liquid.

20. The method of claim 19 further comprising:
surrounding said constricting layer with an outer layer to protect said constricting layer.

21. The method of claim 19 wherein said process of surrounding said carrier and said sensor wires with a conductive layer comprises:
surrounding said carrier and said sensor wires with a conductive layer made from conductive PVC.

22. The method of claim 19 wherein said process of surrounding said carrier and said sensor wires with a conductive layer comprises:
surrounding said carrier and said sensor wires with a conductive layer made from conductive polytetrafluorethylene.

23. The method of claim 19 wherein said process of surrounding said carrier and said sensor wires with a conductive layer comprises:
surrounding said carrier and said sensor wires with a conductive layer made from conductive plastic.

24. The method of claim 23 further comprising:
placing continuity wires in said carrier.

25. The method of claim 19 wherein said process of surrounding said conductive layer with a reactive layer comprises:
surrounding said conductive layer with a nitril blend plastic that swells in the presence of a petrochemical.

26. The method of claim 19 wherein said process of surrounding said conductive layer with a reactive layer comprises:
surrounding said conductive layer with a reactive layer made from SEBS material that swells in the presence of hydrocarbon oils, vegetable oils, and other types of oils.

27. The method of claim 19 wherein said process of surrounding said conductive layer with a reactive layer further comprises:
surrounding said conductive layer with a reactive layer made from a polypropylene-based material that swells in the presence of volatile organic materials, alcohol, ketones and other similar liquids.

28. The method of claim 19 wherein said process of surrounding said conductive layer with a reactive layer further comprises:
surrounding said conductive layer with a reactive layer made from a polyolefin-based material that swells in the presence of volatile organic materials, alcohol, ketones and other similar liquids.

29. The method of claim 19 wherein said process of surrounding said conductive layer with a reactive layer further comprises:
surrounding said conductive layer with a reactive layer made from a polyethylene-based material that swells in the presence of volatile organic materials, alcohol, ketones and other similar liquids.

30. A liquid detection cable for detecting the presence of a liquid comprising:
at least two sensor wires;
a carrier having grooves formed in an outer surface of said carrier and said sensor wires disposed in said grooves so that gaps are present between said sensor wires and an outer surface of said carrier;
a conductive layer disposed around said carrier and said sensor wires that protrudes into said gaps upon application of a force on said conductive layer;
a reactive layer that is disposed around said conductive layer that expands when contacted by said liquid;
a constricting layer surrounding said reactive layer that substantially constricts outward expansion of said reactive layer causing said reactive layer to expand inwardly and generate a force on said conductive layer so that said conductive layer protrudes into said gaps and contacts said at least two sensor wires to provide a conductive path between said at least two sensor wires indicating the presence of said liquid.

31. The liquid detection cable of claim 30 further comprising:
an outer layer that surrounds and protects said constricting layer.

32. The liquid detection cable of claim 30 wherein said conductive layer comprises conductive polyvinylchloride.

33. The liquid detection cable of claim 30 wherein said conductive layer comprises conductive polytetrafluoroethylene.

34. The liquid detection cable of claim 30 wherein said conductive layer comprises conductive plastic.

35. The liquid detection cable of claim 30 further comprising:
continuity wires disposed in said carrier.

36. The liquid detection cable of claim 30 wherein said reactive layer comprises a nitril blend plastic that swells in the presence of a petrochemical.

37. The liquid detection cable of claim 30 wherein said reactive layer comprises an SEBS material that swells in the presence of hydrocarbon oils, vegetable oils, and other types of oils.

38. The liquid detection cable of claim 30 wherein said reactive layer comprises a polypropylene-based material that swells in the presence of volatile organic materials, alcohol, ketones and other similar liquids.

39. The liquid detection cable of claim 30 wherein said reactive layer comprises a polyolefin-based material that swells in the presence of volatile organic materials, alcohol, ketones and other similar liquids.

40. The liquid detection cable of claim 31 wherein said reactive layer comprises a polyethylene-based material that swells in the presence of volatile organic materials, alcohol, ketones and other similar liquids.

41. A method of making a liquid detection cable comprising:
placing a first sensor wire in a groove in a carrier so that a gap is created between an outside surface of said carrier and said first sensor wire;
surrounding said carrier and said first sensor wire with a conductive layer that protrudes into said gap upon application of a force on said conductive layer;
surrounding said conductive layer with a reactive layer that expands when contacted by a liquid;
placing a second sensor wire between said conductive layer and said reactive layer so that said second sensor wire is in electrical contact with said conductive layer;
surrounding said reactive layer with a constricting layer that substantially constricts outward expansion of said reactive layer which causes said reactive layer to expand inwardly and force said conductive layer into said gap so that said conductive layer contacts said first sensor wire and makes an electrical connection between said first sensor wire and said second sensor wire.

42. A liquid detection cable for detecting the presence of a liquid comprising:
a carrier having a groove formed in an outer surface;
a first sensor wire disposed in said groove so that a gap is present between said first sensor wire and an outer surface of said carrier;
a conductive layer disposed around said carrier and said first sensor wire that protrudes into said gap upon application of a force on said conductive layer;
a reactive layer that is disposed around said conductive layer that expands when contacted by said liquid;
a second sensor wire disposed between said conductive layer and said reactive layer so that said second sensor wire is in electrical contact with said conductive layer;
a constricting layer surrounding said reactive layer that substantially constricts outward expansion of said reactive layer causing said reactive layer to expand inwardly and generate a force on said conductive layer so that said conductive layer protrudes into said gap and contacts said first sensor wire to provide a conduction path between said first sensor wire and said second sensor wire through said conductive layer indicating the presence of said liquid.

43. A liquid detection cable comprising:
sensor wire means for carrying a sensor signal;
carrier means having a groove formed in an outer surface for carrying said sensor wire means so that a gap is created between said sensor wire means and said outer surface of said carrier means;
conductive layer means disposed around said carrier means for creating an electrical path between said conductive layer and said sensor wire means when said conductive layer means protrudes into said groove upon application of a force on said conductive layer means;
reactive layer means for absorbing and swelling in the presence of said liquid;
constricting layer means disposed around said reactive layer means for constricting outward expansion of said reactive layer means and causing said reactive layer means to expand inwardly and generate said force on said conductive layer means so that said conductive layer means fills said gap and creates an electrical path between said sensor wire means.
